(19) United States
(12) Patent Application Publication
(10) Pub. No.: US 2024/0003026 A1
(43) Pub. Date: Jan. 4, 2024

(54) CARBON DIOXIDE REDUCTION CATALYST COMPRISING MODIFIED ZIF-BASED COMPOUND, AND CARBON DIOXIDE REDUCTION ELECTRODE COMPRISING SAME

(71) Applicant: LOTTE CHEMICAL CORPORATION, Seoul (KR)

(72) Inventors: Sang Sun Park, Daejeon (KR); Myung Gi Seo, Daejeon (KR); Sung Joon Park, Daejeon (KR); Seon He Kang, Daejeon (KR); Hyung Ki Min, Daejeon (KR); Jin Hyuk Cho, Seoul (KR); Sung Hyun Hong, Seoul (KR); Soo Young Kim, Seoul (KR); Sang Hyun Ahn, Seoul (KR)

(73) Assignee: LOTTE CHEMICAL CORPORATION, Seoul (KR)

(21) Appl. No.: 18/255,635

(22) PCT Filed: Dec. 3, 2021
(86) PCT No.: PCT/KR2021/018188

§ 371 Date: Jun. 2, 2023

(30) Foreign Application Priority Data
Dec. 4, 2020 (KR) 10-2020-0168081

(51) Int. Cl. C25B 11/095; C25B 11/052; C25B 11/065; C25B 11/031; C25B 1/23

(52) U.S. Cl. CPC C25B 11/095; C25B 11/052; C25B 11/065; C25B 11/031; C25B 1/23; C25B 3/26

(57) ABSTRACT

The present invention relates to: a carbon dioxide reduction catalyst comprising a modified ZIF (zeolitic imidazolate framework)-based compound in which copper (Cu) is doped on a ZIF-based compound having a structure in which zinc (Zn) and an imidazole-based organic material are bound; and a carbon dioxide reduction electrode comprising same.

### TECHNICAL FIELD

The present invention relates to a carbon dioxide reduction catalyst comprising a modified ZIF-based compound and a carbon dioxide reduction electrode comprising the same.

### BACKGROUND ART

Carbon dioxide emitted from the indiscriminate use of fossil fuels has caused major problems in human society, such as the greenhouse effect and disturbance of the ecosystem. In order to overcome this, research is being conducted on methods that not only store carbon dioxide using a technology for converting carbon dioxide, but also convert carbon dioxide into useful resources to consume them in various fields. As a technology for converting carbon dioxide, there are photochemical, electrochemical, biochemical, or other methods, and the electrochemical method among them is expected to be the most suitable method for commercialization. The electrochemical method has advantages in that it can convert carbon dioxide into various compounds (HCOOH, CH₄, CO, and C₂H₂) during converting carbon dioxide depending on the type of catalyst, intensity of voltage, and reaction conditions, and can control the selectivity of the compounds.

Carbon monoxide, one of the compounds that can be obtained through carbon dioxide conversion, is mainly selected as a target compound for electrochemical reactions for carbon dioxide conversion since it can be used in fuels and chemical processes. Materials showing high efficiency as a catalyst for converting carbon dioxide into carbon monoxide include noble metals such as gold, silver, etc., and transition metals such as lead, palladium, etc. However, in the case of noble metal catalysts such as gold, silver, etc., there is a problem in that costs of the catalysts are high so that it is difficult to use them, and in the case of transition metal catalysts such as lead, palladium, etc., there is a problem in that they cause air pollution.

Therefore, there is a need for research on a novel catalyst that has a high conversion rate of carbon dioxide to carbon monoxide, does not cause environmental pollution, and can be supplied at low cost.

### PRIOR ART DOCUMENT

### Patent Document

(Patent Document 1) Korean Patent Laid-Open Publication No. 10-2017-0106608

### DISCLOSURE

### Technical Problem

The present invention is directed to providing a novel carbon dioxide reduction catalyst capable of overcoming the problems described above and a carbon dioxide reduction electrode including the same.

### Technical Solution

One aspect of the present invention provides a carbon dioxide reduction catalyst including a modified ZIF (zeolitic imidazolate framework)-based compound in which copper (Cu) is doped on a ZIF-based compound having a structure in which zinc (Zn) and an imidazole-based organic material are bound. The other aspect of the present invention provides a carbon dioxide reduction electrode including the carbon dioxide reduction catalyst.

### Advantageous Effects

A carbon dioxide reduction catalyst according to an exemplary embodiment of the present invention has advantages of having an excellent conversion rate to carbon monoxide during electrochemical carbon dioxide reduction, being inexpensive, and having less environmental burden.

### DESCRIPTION OF DRAWINGS

FIG. 1 illustrates a mimetic diagram of a preparation process of the modified ZIF-based compound according to Example 5.

FIG. 2 illustrates scanning electron microscope (SEM) images of the modified ZIF-based compound prepared according to Example 5.

FIG. 3 illustrates results of X-ray diffraction (XRD) analysis of the modified ZIF-based compound prepared according to Example 5.

FIG. 4 illustrates Faradaic efficiencies of carbon monoxide generation of carbon dioxide reduction electrodes according to Examples and Comparative Example.

### MODES OF THE INVENTION

In this specification, when a part is said to “include” a certain component, it means that it may further include other components without excluding other components unless specifically stated otherwise.

As a result of research on a carbon dioxide reduction catalyst by an electrochemical method, the present inventors have completed the present invention by confirming that an excellent conversion rate to carbon monoxide is exhibited when copper is optimally doped on a ZIF-based compound.

Hereinafter, the present invention will be described in detail.

One embodiment of the present invention provides a carbon dioxide reduction catalyst including a modified ZIF (zeolitic imidazolate framework)-based compound in which copper (Cu) is doped on a ZIF-based compound having a structure in which zinc (Zn) and an imidazole-based organic material are bound.

A zeolitic imidazolate framework (ZIF)-based compound, as a type of metal organic frameworks (MOFs), is a microporous crystal material composed of metal atoms or metal clusters and organic linkages connecting them through coordinate bonds. The MOFs are being actively researched as promising catalysts due to the advantage that they can maximize the desired pore size, shape, and chemical properties through an appropriate combination of metal clusters and ions with organic ligands. Furthermore, since the MOFs can have a very large surface area of up to 7,140 m², they are highly useful as a catalyst.

The ZIF-based compound consists of a metal ion (usually zinc or cobalt) linked to an imidazolate (or imidazolate derivative) ligand. The metal-linkage-metal bond angle of the ZIF-based compound is close to the Si—O—Si bond angle found in many zeolites, but has a clear difference in its constituent elements. Therefore, such a ZIF-based compound has attracted a lot of attention since it has excellent thermal and chemical stability together with ultrafine porosity.

The modified ZIF-based compound according to an exemplary embodiment of the present invention has achieved high conversion efficiency of carbon dioxide to carbon monoxide by doping the ZIF-based compound with copper (Cu), which is a transition metal. When a copper (Cu) catalyst is applied as a carbon dioxide reduction catalyst, carbon dioxide is converted into various compounds during the conversion of carbon dioxide depending on the applied voltage, and thus, a problem of low selectivity to carbon monoxide occurs. In contrast, in the case of substituting copper (Cu) for zinc (Zn) in the ZIF structure by doping copper (Cu) on a ZIF-based compound as in the present invention, as an effect according to the change in chemical structure and form, high Faradaic efficiency for carbon monoxide (up to 81.8% (−1.0 V_{RHE})), high carbon monoxide product concentration (4,545 ppm (−1.2 V_{RHE})), and high current density (−19 mA cm⁻² (−1.2 V_{RHE})) can be implemented during the electrochemical reduction of carbon dioxide.

According to an exemplary embodiment of the present invention, the doping amount of copper (Cu) may be 10 mol % or more and 60 mol % or less with respect to the total number of moles of zinc (Zn) and copper (Cu) of the modified ZIF-based compound. Specifically, the doping amount of copper (Cu) may be more than 40 mol % and 60 mol % or less, or 45 mol % or more and 55 mol % or less with respect to the total number of moles of zinc (Zn) and copper (Cu) of the modified ZIF-based compound. When the doping amount of copper (Cu) exceeds 60 mol % in the modified ZIF-based compound, the content of zinc (Zn) forming the main skeleton is reduced, there may be a problem of making it difficult to prepare the ZiF-based compound.

In general, the ZIF-based compound may be prepared by being combined with imidazole derivatives that are not substituted with other functional group than hydrogen so that one or more metal ions among Cd, Zn, Co, B, Mg, Cu, and Mn and No. 1 nitrogen and No. 3 nitrogen of the imidazole ring may be bonded to the metal ions.

According to an exemplary embodiment of the present invention, the imidazole-based organic material as an organic material in the modified ZIF-based compound may include at least one of imidazole, 2-methylimidazole, and benzimidazole.

According to an exemplary embodiment of the present invention, in the modified ZIF-based compound, a nitrogen atom of the imidazole-based organic material may form a coordination bond with at least one of zinc (Zn) and copper (Cu).

According to an exemplary embodiment of the present invention, the carbon dioxide reduction catalyst may contain at least 50% by weight of the modified ZIF-based compound, and specifically, 80 wt. % or more, or 90 wt. % or more of the modified ZIF-based compound, and more specifically, 100% by weight of the modified ZIF-based compound.

One embodiment of the present invention provides a carbon dioxide reduction electrode including the carbon dioxide reduction catalyst.

According to one embodiment of the present invention, the carbon dioxide reduction electrode may be one in which the carbon dioxide reduction catalyst is supported on a porous carbon support.

According to one embodiment of the present invention, the porous carbon support may include at least one selected from the group consisting of graphene, graphene oxide, fullerene, carbon nanotube (CNT), carbon nanofiber, carbon nanobelt, carbon nanoonion, carbon nanohorn, activated carbon, graphite, and carbon paper. Specifically, the porous carbon support may be carbon paper. More specifically, the carbon dioxide reduction electrode may include the carbon dioxide reduction catalyst formed in a particulate form on carbon paper.

Hereinafter, Examples will be described in detail to explain the present invention in detail. However, embodiments according to the present invention can be modified in many different forms, and the scope of the present invention is not construed as being limited to the Examples described below. The embodiments of the present invention are provided to more completely explain the present invention to those skilled in the art.

### Example 1

0.9 mM of Zn(NO₃)₂·6H₂O and 0.1 mM of Cu(NO₃)₂·3H₂O were put into a 20 ml glass vial containing 10 ml of methanol so that the total molar number was 1 mM, and then sonicated for 10 minutes. Then, 7.5 mM (650 mg) of 2-methylimidazole and 10 ml of methanol were put into another 20 ml glass vial, and then sonicated for 10 minutes.

The mixtures in the two glass vials was transferred to and contained into a 70 mL glass vial, a magnetic bar was inserted thereinto, and then the mixtures were stirred at room temperature for 1 hour. Then, the magnetic bar was taken out, the stirred mixture was left alone at room temperature for 4 hours, and then centrifuged to obtain light brown crystals. The obtained crystals were washed 4 times with methanol and dried under vacuum conditions of 100° C. to obtain a modified ZIF-based compound (ZIF-8/Cu_{10%}).

Carbon paper having a size of 2×2 cm was put into a mixed solution of 20 ml of nitric acid (69%) and 40 ml of tertiary distilled water, and then sonicated for 30 minutes to treat the surface of carbon paper. Then, surface-treated carbon paper was put into 40 ml of 32nd distilled water and sonicated for 30 minutes to remove impurities.

Furthermore, after 0.1 g of the obtained modified ZIF-based compound and 1 ml of DMF were put into a plastic vial (2 ml) and made into a state of an aqueous solution through sonication for 30 minutes, this was applied to surface-treated carbon paper, and dried at 80° C. for 10 minutes to prepare a carbon dioxide reduction electrode.

### Example 2

A modified ZIF-based compound (ZIF-8/Cu_{20%}) was obtained in the same manner as in Example 1 except that the mole numbers of Zn(NO₃)₂·6H₂O and Cu(NO₃)₂·3H₂O were adjusted to 0.8 mM and 0.2 mM, respectively, and a carbon dioxide reduction electrode was prepared in the same manner.

### Example 3

A modified ZIF-based compound (ZIF-8/Cu_{30%}) was obtained in the same manner as in Example 1 except that the mole numbers of Zn(NO₃)₂·6H₂O and Cu(NO₃)₂·3H₂O were adjusted to 0.7 mM and 0.3 mM, respectively, and a carbon dioxide reduction electrode was prepared in the same manner.

### Example 4

A modified ZIF-based compound (ZIF-8/Cu_{40%}) was obtained in the same manner as in Example 1 except that the mole numbers of Zn(NO₃)₂·6H₂O and Cu(NO₃)₂·3H₂O were adjusted to 0.6 mM and 0.4 mM, respectively, and a carbon dioxide reduction electrode was prepared in the same manner

### Example 5

A modified ZIF-based compound (ZIF-8/Cu₄₀%) was obtained in the same manner as in Example 1 except that the mole numbers of Zn(NO₃)₂·6H₂O and Cu(NO₃)₂·3H₂O were adjusted to 0.5 mM and 0.5 mM, respectively, and a carbon dioxide reduction electrode was prepared in the same manner.

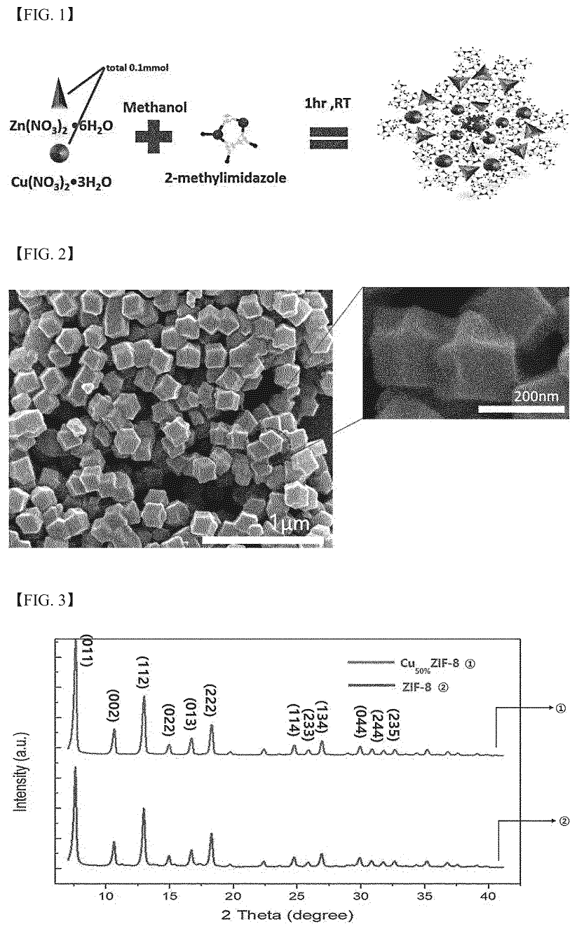

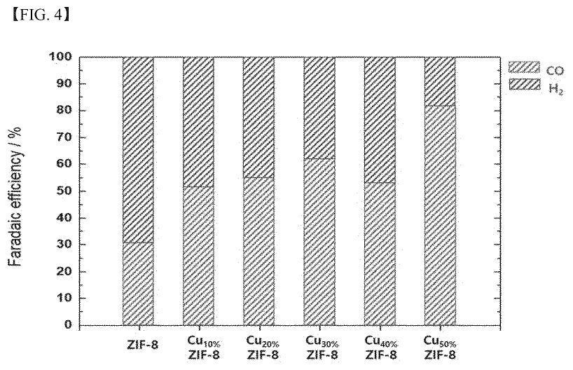

FIG. 1 illustrates a mimetic diagram of a preparation process of the modified ZIF-based compound according to Example 5. Furthermore, FIG. 2 illustrates scanning electron microscope (SEM) images of the modified ZIF-based compound prepared according to Example 5. According to the SEM images of FIG. 2, it can be confirmed that the crystal structure of ZIF-8 does not change even when copper is doped. Furthermore, FIG. 3 illustrates results of X-ray diffraction (XRD) analysis of the modified ZIF-based compound prepared according to Example 5. According to the XRD analysis results of FIG. 3, the crystal of the modified ZIF-based compound prepared according to Example 5 displayed a central cubic crystal lattice, and it could be confirmed from this that the crystal structure of ZIF-8 did not change even when copper was doped. Furthermore, when copper is doped, it is confirmed that the full width at half maximum is reduced at the (011) peak, which means that the size of the crystal increases. Also, it is confirmed that the crystal structure of Zn-MOF-8 does not change even when copper is doped.

### Reference Example 1

A modified ZIF-based compound (ZIF-8/Cu_{60%}) was obtained in the same manner as in Example 1 except that the mole numbers of Zn(NO₃)₂·6H₂O and

Cu(NO₃)₂·3H₂O were adjusted to 0.4 mM and 0.6 mM, respectively, and a carbon dioxide reduction electrode was prepared in the same manner.

However, in the case of Reference Example 1, the amount of the modified ZIF-based compound obtained was too small so that, when carbon dioxide was reduced using the carbon dioxide reduction electrode, not only the current density value was not measured, but also CO was not produced.

### Reference Example 2

A modified ZIF-based compound (ZIF-8/Cu_{70%}) was prepared in the same manner as in Example 1 except that the mole numbers of Zn(NO₃)₂·6H₂O and Cu(NO₃)₂·3H₂O were adjusted to 0.3 mM and 0.7 mM, respectively, but any crystals were hardly obtained after centrifugation. It was determined from this that the crystals were not produced since the content of zinc (Zn), which is the main element constituting the ZIF-8 crystal, was too low.

### Comparative Example 1

Except that Zn(NO₃)₂·6H₂O was applied in an amount of 1 mM without Cu(NO₃)₂·3H₂O, a ZIF-based compound (ZIF-8) was obtained in the same manner as in Example 1, and a carbon dioxide reduction electrode was prepared in the same manner.

The solution compositions and synthesis conditions for preparing the modified ZIF-based compounds according to Examples 1 to 5 and the ZIF-based compound according to Comparative Example 1 are summarized and shown in Table 1 below.

TABLE 1

| Solution | Comparative | | Example 1 | | Example 2 | | Example 3 | | Example 4 | | Example 5 | |
|---|---|---|---|---|---|---|---|---|---|---|---|---|
| compositions | Example 1 | | ZIF- | | ZIF- | | ZIF- | | ZIF- | | ZIF- | |
| and conditions | ZIF-8 | | 8/Cu_{10%} | | 8/Cu_{20%} | | 8/Cu_{30%} | | 8/Cu_{40%} | | 8/Cu_{50%} | |
| Zn(NO3)2•6H₂O | 1 | mM | 0.9 | mM | 0.8 | mM | 0.7 | mM | 0.6 | mM | 0.5 | mM |
| Cu(NO₃)2•3H₂O | 0 | | 0.1 | mM | 0.2 | mM | 0.3 | Mm | 0.4 | Mm | 0.5 | mM |
| C₄H₆N₂ | 7.5 | mM | 7.5 | mM | 7.5 | mM | 7.5 | mM | 7.5 | mM | 7.5 | mM |
| Methanol | 20 | ml | 20 | ml | 20 | ml | 20 | ml | 20 | ml | 20 | ml |
| Temperature | 25° | C. | 25° | C. | 25° | C. | 25° | C. | 25° | C. | 25° | C. |
| Pressure | 1 | atm | 1 | atm | 1 | atm | 1 | atm | 1 | atm | 1 | atm |
| Synthesis time | 24 | hours | 5 | hours | 5 | hours | 5 | hours | 5 | hours | 5 | hours |

### Experimental Example

Electrochemical performances using gas chromatography were measured by using the carbon dioxide reduction electrodes prepared according to Examples 1 to 5 and Comparative Example 1. Electrochemical performances were measured using an H-type cell in which an anode (25 ml) and a cathode (25 ml) were partitioned with a proton exchange membrane (Nafion 212 membrane). As a working electrode, a carbon dioxide reduction electrode having a size of 1×1 cm according to Examples and Comparative Example was exposed by about 0.5 cm² and inserted into a holder to be used as a rotating disk electrode. In addition, a saturated calomel electrode was used as a reference electrode, and a platinum mesh (thickness: 100 μm, area: 4 cm²) was used as a counter electrode. 0.5 M KHCO₃ (pH 7.3) was used as an electrolyte, and purging was progressed for 30 minutes with carbon dioxide and nitrogen gas respectively in order to make this into the catholyte and the anolyte. In addition, 10 sccm of carbon dioxide was continuously injected in order to maintain the saturation state of carbon dioxide in the catholyte before the experiment. The current density of the carbon dioxide reduction electrode was confirmed at various currents of −0.6 V_{RHE} to −1.2 V_{RHE} for 30 minutes by using chronoamperometric measurements. Furthermore, the produced product was detected for 10 minutes using gas chromatography.

The results of the experimental example using the carbon dioxide reduction electrodes according to Examples and Comparative Example are shown in Table 2 below.

TABLE 2

| | | | | | | CO |
|---|---|---|---|---|---|---|
| | Current | | | CO | H₂ | Faradaic |
| Sample | density | | V_{RHE} | (ppm) | (ppm) | efficiency |
| Comparative | −5.3 | mA cm⁻² | −1.0 | 283 | 691 | 30% |
| Example 1 | | | | | | |
| ZIF-8 | | | | | | |
| Example 1 | −7.2 | mA cm⁻² | −1.0 | 1,700 | 1,500 | 53% |
| ZIF-8/Cu_{10%} | | | | | | |
| Example 2 | −9.4 | mA cm⁻² | −1.0 | 1,200 | 960 | 55% |
| ZIF-8/Cu_{20%} | | | | | | |
| Example 3 | −4.8 | mA cm⁻² | −1.0 | 1,600 | 1,000 | 62% |
| ZIF-8/Cu_{30%} | | | | | | |
| Example 4 | −7.3 | mA cm⁻² | −1.0 | 1,700 | 1,400 | 54% |
| ZIF-8/Cu_{40%} | | | | | | |
| Example 5 | −4.6 | mA cm−² | −1.0 | 1,307 | 290 | 81.8% |
| ZIF-8/Cu_{50%} | | | | | | |

FIG. 4 illustrates Faradaic efficiencies of carbon monoxide generation of carbon dioxide reduction electrodes according to Examples and Comparative Example.

According to Table 2 and FIG. 4, Comparative Example 1, which is a carbon dioxide reduction electrode including a ZiF-based compound that is not doped with copper (Cu), showed the lowest concentration of CO product (283 ppm) and lowest CO Faradaic efficiency (30%). In contrast, it can be confirmed that Examples 1 to 5 including the modified ZiF-based compound doped with copper (Cu) show a minimum 53% of CO Faradaic efficiency and a high CO product concentration.

Furthermore, the current density, CO product concentration, H₂ product concentration, and CO Faradaic efficiency of Example 5 (ZIF-8/Cu_{50%}), which showed the best results in Experimental Example described above, were confirmed at various voltages, and are shown in Table 3 below. At this time, it proceeded in the same manner as in Example except that a carbon dioxide reduction electrode having a size of 2×2 cm was used and the exposed portion was 1 cm². Through this, it could be confirmed that as the exposed area of the carbon dioxide reduction electrode widened, a large amount of CO concentration and a high current density could be exhibited.

TABLE 3

| | | | | | | CO |
|---|---|---|---|---|---|---|
| | Current | | | CO | H₂ | Faradaic |
| Sample | density | | V_{RHE} | (ppm) | (ppm) | efficiency |
| Example 5 | −0.65 | mA cm⁻² | −0.6 | 44 | 199 | 18% |
| ZIF-8/Cu_{50%} | −1.7 | mA cm⁻² | −0.7 | 335 | 728 | 31% |
| | −11.41 | mA cm⁻² | −1.1 | 3,680 | 952 | 79% |
| | −19 | mA cm⁻² | −1.2 | 4,545 | 6,784 | 40% |

According to Table 3, when V_{RHE} was −1.2 V, the current density reached a maximum of −19 mA cm⁻², and when V_{RHE} was −1.1 V, a Faradaic efficiency of 79% and a very high CO product concentration of 3,680 ppm were shown. As a result, it could be confirmed that the modified ZIF-based compound (ZIF-8/Cu_{50%}) according to Example 5 shows the catalyst performance capable of realizing the CO product concentration (up to 3,000 ppm) comparable to gold (Au) or silver (Ag) catalysts as well as high Faradaic efficiency and high current density.

1. A carbon dioxide reduction catalyst comprising a modified ZIF (zeolitic imidazolate framework)-based compound in which copper (Cu) is doped on a ZIF-based compound having a structure in which zinc (Zn) and an imidazole-based organic material are bound.

2. The carbon dioxide reduction catalyst of claim 1, wherein the doping amount of copper (Cu) is 10 mol % or more and 60 mol % or less with respect to the total number of moles of zinc (Zn) and copper (Cu) of the modified ZIF-based compound.

3. The carbon dioxide reduction catalyst of claim 1, wherein the imidazole-based organic material includes at least one of imidazole, 2-methylimidazole, and benzimidazole.

4. The carbon dioxide reduction catalyst of claim 1, wherein in the modified ZIF-based compound, a nitrogen atom of the imidazole-based organic material forms a coordination bond with at least one of zinc (Zn) and copper (Cu).

5. A carbon dioxide reduction electrode comprising the carbon dioxide reduction catalyst according to claim 1.

6. The carbon dioxide reduction electrode of claim 5, wherein the carbon dioxide reduction electrode is one in which the carbon dioxide reduction catalyst is supported on a porous carbon support.
